(19) United States
(12) Patent Application Publication
(10) Pub. No.: US 2024/0389118 A1
(43) Pub. Date: Nov. 21, 2024

(54) METHOD AND APPARATUS FOR SIDELINK POSITIONING REFERENCE SIGNAL TRANSMISSION

(71) Applicant: Lenovo (Beijing) Limited, Beijing (CN)

(72) Inventors: Xiaodong Yu, Beijing (CN); Zhennian Sun, Beijing (CN); Haipeng Lei, Beijing (CN); Haiming Wang, Beijing (CN); Jie Hu, Beijing (CN); Xin Guo, Beijing (CN)

(73) Assignee: Lenovo (Beijing) Limited, Beijing (CN)

(21) Appl. No.: 18/696,853

(22) PCT Filed: Sep. 30, 2021
(86) PCT No.: PCT/CN2021/122435

§ 371 Date: Mar. 28, 2024

(51) Int. Cl. H04W 72/25; H04L 5/00; H04W 92/18

(52) U.S. Cl. CPC H04W 72/25; H04L 5/0048; H04W 92/18

(57) ABSTRACT

Embodiments of the present disclosure relate to sidelink (SL) positioning reference signal (PRS) transmission in a wireless communication system. According to some embodiments of the disclosure. a user equipment (UE) may include: a transceiver: and a processor coupled to the transceiver. The processor may be configured to: receive an interlace-based sidelink (SL) positioning reference signal (PRS) configuration; and transmit an SL PRS on an unlicensed band according to a result of a channel access procedure on the unlicensed band and the SL PRS configuration.

### TECHNICAL FIELD

Embodiments of the present disclosure generally relate to wireless communication technology, and more particularly to sidelink (SL) positioning reference signal (PRS) transmission on licensed spectrums.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In some wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

Some wireless communication systems may support sidelink communications, in which devices (e.g., UEs) that are relatively close to each other may communicate with one another directly via a sidelink (SL), rather than being linked through the BS. The term “SL” may refer to a direct radio link established for communicating among devices, as opposed to communicating via a cellular infrastructure (e.g., uplink and downlink). The term “SL” may also be referred to as a sidelink communication link.

The industry desires technologies for SL positioning reference signal (PRS) transmission in a communication system.

### SUMMARY

Some embodiments of the present disclosure provide a user equipment (UE). The UE may include: a transceiver; and a processor coupled to the transceiver. The processor may be configured to: receive an interlace-based sidelink (SL) positioning reference signal (PRS) configuration; and transmit an SL PRS on an unlicensed band according to a result of a channel access procedure on the unlicensed band and the SL PRS configuration. The SL PRS configuration may be received from another UE or a network node.

Some embodiments of the present disclosure provide a user equipment (UE). The UE may include: a transceiver; and a processor coupled to the transceiver. The processor may be configured to: detect, on an unlicensed band, a transmission band of a sidelink (SL) positioning reference signal (PRS) according to an interlace-based SL PRS configuration; and receive the SL PRS on the transmission band according to the interlace-based SL PRS configuration.

The processor may be further configured to transmit the interlace-based SL PRS configuration. The SL PRS configuration may indicate at least one of: a maximum number of occupied subbands or a set of occupied subband numbers; a maximum number of interlaces or a set of interlace indexes in a subband or a system bandwidth; or the number of symbols N for transmitting the SL PRS, wherein the bandwidth of the subband corresponds to that of a single channel access procedure on the unlicensed band.

The receive the SL PRS on the transmission band, the processor may be configured to: in response to the bandwidth of the transmission band being equal to the maximum number of occupied subbands, receive the SL PRS at N symbols in the transmission band; or in response to the bandwidth of the transmission band being smaller than the maximum number of occupied subbands, receive the SL PRS at a plurality of N symbols in the transmission band. The processor may be further configured to in response to the bandwidth of the transmission band being smaller than the maximum number of occupied subbands, receive the SL PRS mapped to a first N symbols of a plurality of N symbols or the SL PRS mapped to a second N symbols of the plurality of N symbols at a sensing region corresponding to the SL PRS mapped to the second N symbols. The SL PRS received at a second N symbols of the plurality of N symbols may be generated based on a symbol index or slot index of the first N symbols of a plurality of N symbols. The SL PRS may be mapped according to a frequency first and time second manner from the lowest frequency to the highest frequency.

Some embodiments of the present disclosure provide a network node. The network node may include: a transceiver; and a processor coupled to the transceiver. The processor may be configured to: transmit an interlace-based sidelink (SL) positioning reference signal (PRS) configuration, wherein the SL PRS configuration indicates at least one of: a maximum number of occupied subbands or a set of occupied subband numbers; a maximum number of interlaces or a set of interlace indexes in a subband or a system bandwidth; or the number of symbols N for transmitting the SL PRS, wherein the bandwidth of the subband corresponds to that of a single channel access procedure on an unlicensed band.

Some embodiments of the present disclosure provide a method for wireless communication. The method may include: receiving an interlace-based sidelink (SL) positioning reference signal (PRS) configuration; and transmitting an SL PRS on an unlicensed band according to a result of a channel access procedure on the unlicensed band and the SL PRS configuration.

Some embodiments of the present disclosure provide a method for wireless communication. The method may include: detecting, on an unlicensed band, a transmission band of a sidelink (SL) positioning reference signal (PRS) according to an interlace-based SL PRS configuration; and receiving the SL PRS on the transmission band according to the interlace-based SL PRS configuration.

Some embodiments of the present disclosure provide a method for wireless communication. The method may include: transmitting an interlace-based sidelink (SL) positioning reference signal (PRS) configuration, wherein the SL PRS configuration indicates at least one of: a maximum number of occupied subbands or a set of occupied subband numbers; a maximum number of interlaces or a set of interlace indexes in a subband or a system bandwidth; or the number of symbols N for transmitting the SL PRS, wherein the bandwidth of the subband corresponds to that of a single channel access procedure on an unlicensed band.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate and improve the implementation of various communication technologies, such as 5G NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2A illustrates a schematic diagram for resource allocation in accordance with some embodiments of the present disclosure;

FIG. 2B illustrates a schematic diagram for resource allocation in accordance with some embodiments of the present disclosure;

FIG. 3 illustrates a schematic diagram of an SL PRS transmission in accordance with some embodiments of the present disclosure;

FIG. 4A illustrates an exemplary PRS transmission pattern in accordance with some embodiments of the present disclosure;

FIG. 4B illustrates an exemplary PRS transmission pattern in accordance with some embodiments of the present disclosure;

FIG. 4C illustrates an exemplary PRS transmission pattern in accordance with some embodiments of the present disclosure;

FIG. 5A illustrates a schematic diagram of SL PRS mapping in accordance with some embodiments of the present disclosure;

FIG. 5B illustrates a schematic diagram of SL PRS mapping in accordance with some embodiments of the present disclosure;

FIG. 5C illustrates a schematic diagram of SL PRS mapping in accordance with some embodiments of the present disclosure;

FIG. 6 illustrates a flow chart of an exemplary procedure of wireless communications in accordance with some embodiments of the present disclosure;

FIG. 7 illustrates a flow chart of an exemplary procedure of wireless communications in accordance with some embodiments of the present disclosure; and

FIG. 8 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

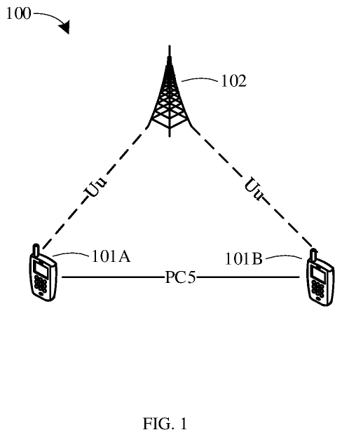

FIG. 1 illustrates a schematic diagram of a wireless communication system 100 in accordance with some embodiments of the present disclosure.

As shown in FIG. 1, the wireless communication system 100 may support sidelink communications. Sidelink communication supports UE-to-UE direct communication. In the context of the present disclosure, sidelink communications may be categorized according to the wireless communication technologies adopted. For example, sidelink communication may include NR sidelink communication and V2X Sidelink communication.

NR sidelink communications (e.g., specified in 3GPP specification TS 38.311) may refer to access stratum (AS) functionality enabling at least vehicle-to-everything (V2X) communications as defined in 3GPP specification TS 23.287 between neighboring UEs, using NR technology but not traversing any network node. V2X sidelink communications (e.g., specified in 3GPP specification TS 36.311) may refer to AS functionality enabling V2X communications as defined in 3GPP specification TS 23.285 between neighboring UEs, using evolved-universal mobile telecommunication system (UMTS) terrestrial radio access (UTRA) (E-UTRA) technology, but not traversing any network node. However, if not being specified, “sidelink communications” may refer to NR sidelink communications, V2X sidelink communications, or any sidelink communications adopting other wireless communication technologies.

Referring to FIG. 1, the wireless communication system 100 may include a base station (e.g., BS 102) and some UEs (e.g., UE 101A and UE 101B). Although a specific number of UEs and BSs is depicted in FIG. 1, it is contemplated that any number of UEs and BSs may be included in the wireless communication system 100.

The UEs and the BS may support communication based on, for example, 3G. long-term evolution (LTE), LTE-advanced (LTE-A), new radio (NR), or other suitable protocol(s). In some embodiments of the present disclosure, a BS (e.g., BS 102) may be referred to as an access point, an access terminal, a base, a base unit, a macro cell, a Node-B, an evolved Node B (eNB), a gNB, an ng-eNB, a Home Node-B, a relay node, or a device, or described using other terminology used in the art. A UE (e.g., UE 101A or UE 101B) may include, for example, but is not limited to, a computing device, a wearable device, a mobile device, an IoT device, a road side unit (RSU), a vehicle, etc. Persons skilled in the art should understand that as technology develops and advances, the terminologies described in the present disclosure may change, but should not affect or limit the principles and spirit of the present disclosure.

In the example of FIG. 1, the BS 102 may be included in a next generation radio access network (NG-RAN). The UE 101A and UE 101B may be in-coverage (e.g., inside the NG-RAN). For example, as shown in FIG. 1, the UE 101A and the UE 101B may be within the coverage of BS 102. The UE 101A and UE 101B may respectively connect to the BS 102 via a network interface, for example, the Uu interface as specified in 3GPP standard documents. The link established between a UE (e.g., UE 101A) and a BS (e.g., BS 102) may be referred to as a Uu link. The UE 101A and UE 101B may communicate with the BS 102 via respective uplink (UL) communication signals. The BS 102 may communicate with UE 101A and UE 101B via respective downlink (DL) communication signals. The UE 101A and UE 101B may be connected via a sidelink, for example, a PC5 interface as specified in 3GPP standard documents. In some other examples, the UE 101A, the UE 101B, or both may be out-of-coverage (e.g., outside the coverage of the NG-RAN). The UE 101A and the UE 101B may communicate with each other via a sidelink.

In some embodiments of the present disclosure, UE 101A may function as a transmitting UE, and UE 101B may function as a receiving UE. UE 101A may transmit information or data to UE 101B, through a sidelink unicast, sidelink groupcast, or sidelink broadcast. For instance, UE 101A may transmit data to UE 101B in a sidelink unicast session. UE 101A may transmit data to UE 101B and other UEs in a groupcast group (not shown in FIG. 1) by a sidelink groupcast transmission session. UE 101A may transmit data to UE 101B and other UEs (not shown in FIG. 1) by a sidelink broadcast transmission session.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE 101A or 101B may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE 101A (or UE 101B) may communicate using other communication protocols, such as the IEEE 802.11 family of wireless communication protocols. Further, in some embodiments of the present disclosure, the BS 102 and UE 101A (or UE 101B) may communicate over licensed spectrums, whereas in some other embodiments, the BS 102 and UE 101A (or UE 101B) may communicate over unlicensed spectrums. UE 101A and UE 101B may communicate with each other over licensed or unlicensed spectrums. The present disclosure is not intended to be limited to the implementation of any particular wireless communication system architecture or protocol.

There is strong demand from industries, such as the automotive vertical industry, that require the support of sidelink positioning. Sidelink positioning provides a new positioning method that fits the industry's various application scenarios. Sidelink positioning, which can be relative or absolute positioning, may include, for example, transmitting positioning reference signals (PRS) over the sidelink. Sidelink positioning has various advantages including, for example, it can operate independent of network or radio access technology (RAT) coverage, and it is very valuable when network based positioning or other positioning methods are not available.

Embodiments of the present disclosure provide solutions to facilitate sidelink positioning. For example, it is considered that the bandwidth of an intelligent transport system (ITS) is very limited and operators may not want to use their licensed spectrum for an SL purpose. It would be beneficial if the SL PRS can be transmitted on unlicensed spectrums.

Wireless transmission on an unlicensed spectrum should meet the requirements of the regulations subject to the management of the country/region where a wireless communication device (e.g., a UE) is located. The design of an uplink waveform for an NR-U PUSCH (Physical Uplink Shared Channel)/PUCCH (physical uplink control channel) should meet these regulation requirements on an unlicensed spectrum. Similarly, the design of a waveform for sidelink communication should also meet the above regulation requirements on an unlicensed spectrum.

For example, the requirements may mainly include two aspects:
(1) occupied channel bandwidth (OCB): the bandwidth containing 99% of the power of the signal, shall be between 80% and 100% of the declared nominal channel bandwidth; and
(2) maximum power spectrum density (PSD) with a resolution bandwidth of 1 MHz (e.g., 10 dBm/MHz).

The above two requirements dictate that a signal which occupies a small portion of the channel bandwidth cannot be transmitted at the maximum available power at the UE due to PSD and OCB constraints.

In Rel-14 LTE enhanced licensed assisted access (LTE eLAA), an interlace-based waveform is employed as an uplink waveform for an unlicensed spectrum. As a frequency resource, an interlace may be defined as a set of resource blocks (RBs) which may be evenly spaced in frequency domain. A 20 MHz bandwidth may include 100 physical resource blocks (PRBs), which are partitioned into 10 interlaces. Each interlace may include 10 PRBs and may be equally distributed within the whole bandwidth. In this way, each interlace spans more than 80% system bandwidth so that the regulation requirements of the OCB can be met. Moreover, 10 PRBs of one interlace are equally spaced in frequency so that two adjacent PRBs of one interlace are separated by a 1.8 MHz distance, and thus power boosting can be realized for each PRB of one interlace.

The interlace-based waveform can also be applied to NR systems to achieve power boosting under a PSD constraint and meet the regulatory requirements defined for the OCB. However, different from LTE with 15 kHz subcarrier spacing, multiple numerologies are defined for NR. For example, the subcarrier spacing may be 15 kHz, 30 kHz, or 60 kHz for frequency range 1 (FR1) and different subcarrier spacing values can support different maximum bandwidths.

Table 1 below shows examples of NR bandwidth configurations for different subcarrier spacing. According to Table 1, a maximum number of RBs (represented as NRB in Table 1) may be determined based on the subcarrier spacing and corresponding bandwidth. As can be seen, maximum numbers of RBs may be different for different subcarrier spacing values even for the same bandwidth. For example, when the bandwidth is 20 MHz and the subcarrier spacing (SCS) is 15 kHz, the maximum number of RBs may be 106; and when the bandwidth is 20 MHz and the SCS is 30 kHz, the maximum number of RBs may be 51. It should be understood that Table 1 is only for illustrative purposes, and should not be construed as limiting the embodiments of the present disclosure.

TABLE 1

| subcarrier | | | | | | | | | | | | |
|---|---|---|---|---|---|---|---|---|---|---|---|---|
| spacing | | | | | | | | | | | | |
| (SCS) | 5 MHz | 10 MHz | 15 MHz | 20 MHz | 25 MHz | 30 MHz | 40 MHz | 50 MHz | 60 MHz | 80 MHz | 90 MHz | 100 MHz |
| (kHz) | N_{RB} | N_{RB} | N_{RB} | N_{RB} | N_{RB} | N_{RB} | N_{RB} | N_{RB} | N_{RB} | N_{RB} | N_{RB} | N_{RB} |
| 15 | 25 | 52 | 79 | 106 | 133 | 160 | 216 | 270 | N/A | N/A | N/A | N/A |
| 30 | 11 | 24 | 38 | 51 | 65 | 78 | 106 | 133 | 162 | 217 | 245 | 273 |
| 60 | N/A | 11 | 18 | 24 | 31 | 38 | 51 | 65 | 79 | 107 | 121 | 135 |

In some embodiments, the number of interlaces in the frequency domain may be dependent on the subcarrier spacing. For example, for a 15 kHz SCS, a 20 Mhz bandwidth may include 10 interlaces with 10 or 11 PRBs per interlace. For a 30 kHz SCS, a 20 Mhz bandwidth may include 5 interlaces with 10 or 11 PRBs per interlace.

An NR-U (NR system access on unlicensed spectrum) operating bandwidth may be an integer multiple of 20 MHz. In order to achieve fair coexistence between NR systems (e.g., NR-U systems) and other wireless systems, a channel access procedure, also known as a listen-before-talk (LBT) test, may be performed, in units of 20 MHz, before communicating on the unlicensed spectrum. For a bandwidth larger than 20 MHz, e.g., 40 MHz, 60 MHz, 80 MHz, or 100 MHz, the carrier bandwidth may be partitioned into subbands, each of which has a bandwidth of 20 MHz and may be indexed.

To perform the LBT test, energy detection may be performed on a certain channel. If the received power of the channel is below a predefined threshold, the LBT test may be determined as successful, and the channel may then be deemed as empty and available for transmission. Only when the LBT test is successful can a device (e.g., a UE) start transmission on the channel and occupy the channel up to a maximum channel occupancy time (MCOT). Otherwise, that is, if the LBT test fails, the device cannot start any transmission on the channel, and may continue to perform another LBT test until a successful LBT test result. A BS or UE may perform the above LBT test per subband (e.g., 20 MHz per subband, which may also be referred to as an “LBT subband”), and may communicate on an available subband(s), if any.

For example, an 80 Mhz system bandwidth may be divided into 4 subbands each having a 20 Mhz bandwidth. An LBT test is performed on each subband separately. For example, when only one of the four subbands is free (available) based on the LBT result, may a UE perform transmissions on the interlace(s) within this subband. When two of the four subbands are free (available) based on the LBT result, a UE may perform transmissions on the interlace(s) within the available two subbands. Similar operations may be performed based on another different LBT result(s).

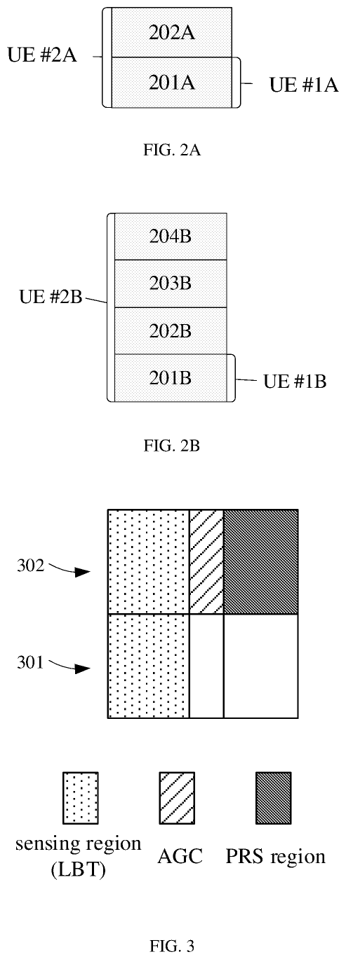

Referring to FIG. 2A, it is assumed that for a 15 kHz SCS and 40 MHz carrier bandwidth, UE #1A's active bandwidth part (BWP) only includes subband 201A and UE #2A's BWP includes subbands 201A and 202A. From UE #1A's perspective, there may be 10 interlaces, interlace 0 may contain PRBs 0, 10, 20, . . . , and 100, interlace 1 may contain PRBs 1, 11, 21, . . . , and 101, and so on. From UE #2A's perspective, there may be 10 interlaces, interlace 0 may contain PRBs 0, 10, 20, . . . , 100, 110, 120, . . . , 200, and 210, interlace 1 may contain PRBs 1, 11, 21, . . . , 101, 111, 121, . . . , 201, and 211, and so on. When interlace 0 is assigned to UE #1A, then interlace 0 cannot be assigned to UE #2A for collision avoidance. In this scenario, the PRBs of interlace 0 in subband 202A, i.e., PRBs 110, 120, . . . , 200, and 210, are wasted.

Referring to FIG. 2B, it is assumed that for a 30 kHz SCS and 80 MHz carrier bandwidth, UE #1B's active bandwidth part (BWP) only includes subband 201B and UE #2B's BWP includes subbands 201B-204B. From UE #1B's perspective, there may be 5 interlaces, interlace 0 may contain PRB 0, 5, 10, 15, . . . , 45, and 50, interlace 1 may contain PRB 1, 6, 11, 16, . . . , and 46, and so on. From UE #2B's perspective, there may be 5 interlaces, interlace 0 may contain PRB 0, 5, 10, 15, 20, . . . , 100, 105, 110, 115, . . . , 205, and 210, interlace 1 may contain PRB 1, 6, 11, 16, 21, . . . , 101, 106, 111, 116, . . . , 206, and 211, and so on. When interlace 0 is assigned to UE #1B, then interlace 0 cannot be assigned to UE #2B for collision avoidance.

In this scenario, the PRBs of interlace 0 in subbands 202B-204B, i.e., PRBs 55, 60, . . . , 205, and 210, are wasted.

Embodiments of the present disclosure provide solutions to facilitate sidelink positioning. For example, it is considered that the bandwidth of an intelligent transport system (ITS) is very limited and operators may not want to use their licensed spectrum for an SL purpose. It would be beneficial if the SL PRS can be transmitted on unlicensed spectrums. More details on the embodiments of the present disclosure will be illustrated in the following text in combination with the appended drawings.

In some embodiments of the present disclosure, the SL PRS transmission on the unlicensed spectrums may consider the LBT results. For example, referring to FIG. 3, a UE may perform respective LBT procedures on the sensing regions of subbands 301 and 302, each of which may have a 20 Mhz bandwidth. The UE may transmit an SL PRS based on the LBT result. For example, in response to subband 301 being unavailable and subband 302 being available, the UE may transmit a signal for automatic gain control (AGC) purpose in the AGC region (optional) and the SL PRS in the PRS region within subband 302.

In some embodiments of the present disclosure, an SL PRS on an unlicensed spectrum may consider the LBT result and the assigned available bandwidth. The size of the SL PRS sequence may be associated with the required positioning accuracy. To ensure the transmission of the entire SL PRS sequence, the transmission of the SL PRS may be subject to the available bandwidth (frequency domain resource) and the number of symbol available for transmission (time domain resource).

A UE (hereinafter, “transmitting UE” or “Tx UE”) may be configured with an interlace-based PRS transmission pattern. The configuration may be from the network (e.g., a BS) or another UE (e.g., the UE which expects the SL PRS or any other UE). The pattern may be configured from the system's perspective. The transmitting UE may need to determine the actual resources for the SL PRS transmission based on the LBT result and the configuration.

In some examples, the configuration may indicate at least one of: a maximum number of occupied subbands or a set of occupied subband numbers; a maximum number of interlaces or a set of interlace indexes in a subband or a system bandwidth (e.g., the carrier bandwidth or the bandwidth of the unlicensed spectrum); or the number of symbols (denoted as “N”) for transmitting the SL PRS. The subband may refer to an LBT subband.

In some embodiments, the maximum number of occupied subbands or the set of occupied subband numbers may be configured per resource pool. In some other embodiments, the maximum number of occupied subbands or the set of occupied subband numbers may be predefined, for example, in a standard(s), based on the carrier bandwidth. For example, for a 40 Mhz system bandwidth, the set of occupied subband number may be {1.2} and the maximum number of an occupied subband number may be 2. The transmitting UE can transmit the SL PRS within one or two subbands. The actual occupied subband number (e.g., 1 or 2) is determined by the transmitting UE based on the LBT result. For an 80 Mhz system bandwidth, the set of occupied subband number may be {1, 2, 3, 4} and the maximum occupied subband number may be 4.

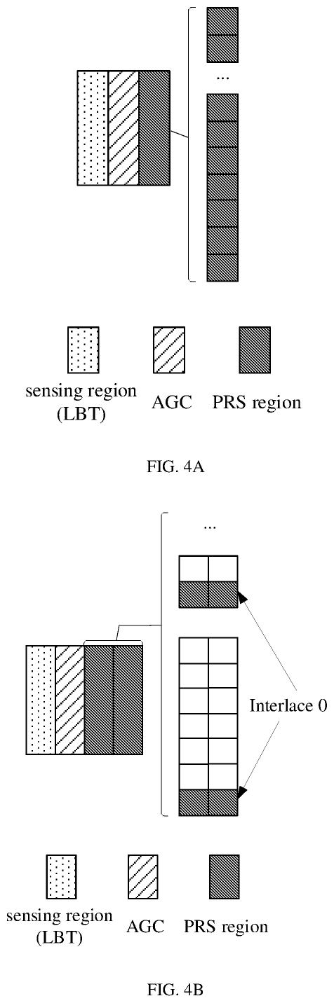

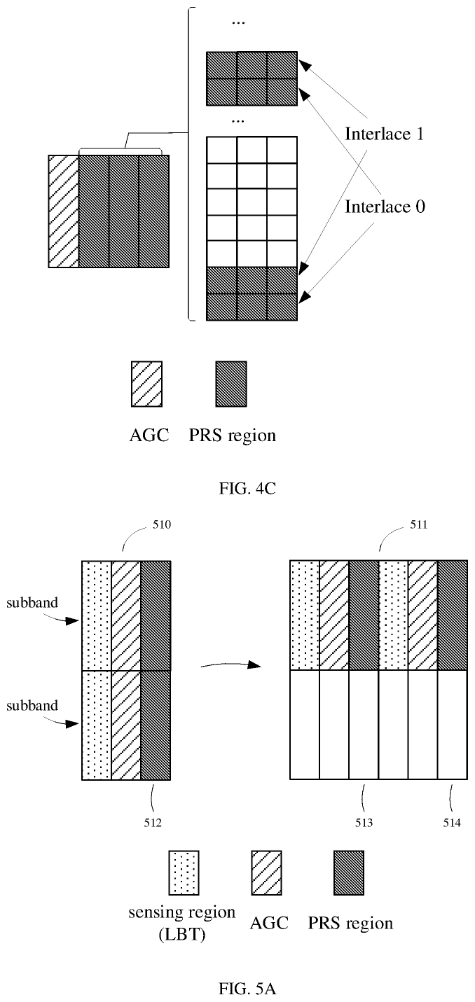

FIGS. 4A-4C illustrate exemplary PRS transmission patterns in accordance with some embodiments of the present disclosure. It should be understood that FIGS. 4A-4C are only for illustrative purposes, and should not be construed as limiting the embodiments of the present disclosure.

As shown in FIG. 4A, the PRS transmission pattern may occupy one symbol in the time domain and all interlaces in a subband or the system bandwidth. The PRS transmission pattern in FIG. 4B may occupy two symbols in the time domain and one interlace (e.g., interlace 0) in a subband or the system bandwidth. The PRS transmission pattern in FIG. 4C may occupy three symbols in the time domain and two interlaces (e.g., interlaces 0 and 1) in a subband or the system bandwidth.

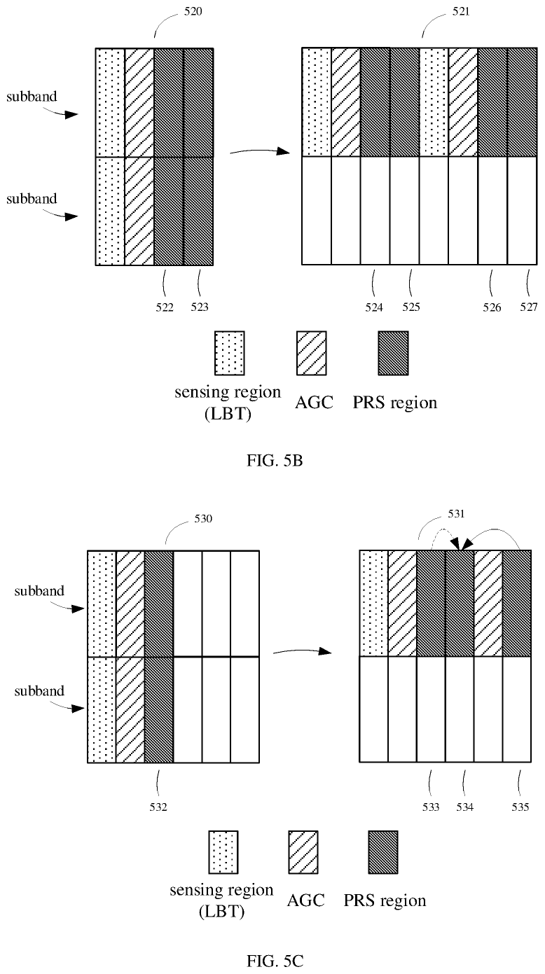

In some embodiments, the transmitting UE may map the SL PRS to be transmitted to resources based on the LBT result and the PRS configuration. FIGS. 5A-5C illustrate a schematic diagram of SL PRS mapping in accordance with some embodiments of the present disclosure. It should be understood that FIGS. 5A-5C are only for illustrative purposes, and should not be construed as limiting the embodiments of the present disclosure.

Referring to FIG. 5A, a UE may be configured with an interlace-based SL PRS configuration indicating that a PRS can occupy a maximum of 2 subbands (e.g., 40 Mhz) and 1 symbol. The UE may perform an LBT test(s) on the unlicensed spectrum. When the LBT result indicates that 2 subbands (i.e., equal to the maximum occupied subband number) is available, the UE may transmit an SL PRS according to PRS pattern 510, where the SL PRS may be transmitted on symbol 512. The specific interlaces for transmitting the PRS can be determined based on the SL PRS configuration. The SL PRS may be generated based on the symbol index or slot index of symbol 512. The generated SL PRS may be mapped to the determined resources based on a frequency first and time second manner from the lowest frequency to the highest frequency.

When the LBT result indicates that a smaller subband number (e.g., 1 subband) is available, the UE may transmit an SL PRS according to PRS pattern 511, where the SL PRS may be transmitted on symbols 513 and 514 so that the entire SL PRS sequence can be transmitted. The specific interlaces for transmitting the PRS can be determined based on the SL PRS configuration. The SL PRS to be mapped to symbols 513 and 514 may be generated based on the symbol index or slot index of one of symbols 513 and 514 (i.e., either symbol 513 or symbol 514). The generated SL PRS may be mapped to the resources in symbols 513 and 514 based on a frequency first and time second manner from the lowest frequency to the highest frequency. For example, the UE may first map the generated PRS sequence to symbol 513 from the lowest frequency to the highest frequency and then to symbol 514 from the lowest frequency to the highest frequency.

Referring to FIG. 5B, a UE may be configured with an interlace-based SL PRS configuration indicating that a PRS can occupy a maximum of 2 subbands (e.g., 40 Mhz) and 2 symbols. The UE may perform an LBT test(s) on the unlicensed spectrum. When the LBT result indicates that 2 subbands (i.e., equal to the maximum occupied subband number) is available, the UE may transmit an SL PRS according to PRS pattern 520, where the SL PRS may be transmitted on symbols 522 and 523. The specific interlaces for transmitting the PRS can be determined based on the SL PRS configuration. The SL PRS may be generated based on the symbol index of symbol 522 or symbol 523 or the slot index of symbol 522 or symbol 523. For example, the SL PRS transmitted on symbol 522 can be generated based on the symbol index of symbol 522 and the SL PRS transmitted on symbol 523 can be generated based on the symbol index of symbol 523. The generated SL PRS may be mapped to the determined resources based on a frequency first and time second manner from the lowest frequency to the highest frequency. For example, the UE may first map the generated PRS sequence to symbol 522 from the lowest frequency to the highest frequency and then to symbol 523 from the lowest frequency to the highest frequency.

When the LBT result indicates that a smaller subband number (e.g., 1 subband) is available, the UE may transmit an SL PRS according to PRS pattern 521. where the SL PRS may be transmitted on symbols 524-527 so that the entire SL PRS sequence can be transmitted. The SL PRS to be mapped to symbols 524-527 may be generated based on the symbol index or slot index of symbol 524 or 525 or based on the symbol index or slot index of symbol 526 or 527. For example, the SL PRS to be mapped to symbols 524 and 525 may be generated based on the symbol indexes of symbols 524 and 525, respectively, and the SL PRS to be mapped to symbols 526 and 527 may be generated based on the symbol indexes of symbols 524 and 525, respectively. For example, the SL PRS to be mapped to symbols 524 and 525 may be generated based on the symbol indexes of symbols 526 and 527, respectively, and the SL PRS to be mapped to symbols 526 and 527 may be generated based on the symbol indexes of symbols 526 and 527, respectively. The generated SL PRS may be mapped to the resources in symbols 524-527 based on a frequency first and time second manner from the lowest frequency to the highest frequency. For example, the UE may first map the generated PRS sequence to symbol 524 from the lowest frequency to the highest frequency, then to symbol 525 from the lowest frequency to the highest frequency, and so on.

Referring to FIG. 5C. a UE may be configured with an interlace-based SL PRS configuration indicating that a PRS can occupy a maximum of 2 subbands (e.g., 40 Mhz) and 1 symbol. The UE may perform an LBT test(s) on the unlicensed spectrum. When the LBT result indicates that 2 subbands (i.e., equal to the maximum occupied subband number) is available, the UE may transmit an SL PRS according to PRS pattern 530, where the SL PRS may be transmitted on symbol 532. The specific interlaces for transmitting the PRS can be determined based on the SL PRS configuration.

When the LBT result indicates that a smaller subband number (e.g., 1 subband) is available, the UE may transmit an SL PRS according to PRS pattern 531, where the SL PRS may be transmitted on symbols 533 and 535 so that the entire SL PRS sequence can be transmitted. The specific interlaces for transmitting the PRS can be determined based on the SL PRS configuration. The SL PRS to be mapped to symbols 533 and 535 may be generated based on the symbol index or slot index of one of symbols 533 and 535 (i.e., either symbol 533 or symbol 535). The generated SL PRS may be mapped to the resources in symbols 533 and 535 based on a frequency first and time second manner from the lowest frequency to the highest frequency.

FIG. 5C is similar to FIG. 5A except that symbol 515 in FIG. 5A may correspond to a sensing region and symbol 534 in FIG. 5C (which corresponds to symbol 515 in FIG. 5A) may be used to transmit a repetition of the SL PRS when the LBT result indicates that a smaller subband number (e.g., 1 subband) is available. For example, the SL PRS mapped to symbol 533 or 535 may be copied to symbol 534. This is beneficial because it is not necessary to perform an LBT test in the sensing region corresponding to symbol 534 and the mapped SL PRS on symbol 534 can help to occupy the channel for subsequence transmission, and a repetition of the SL PRS on the symbol before symbol 535 may be used for AGC purpose. In addition, copying the SL PRS mapped to symbol 535 to symbol 534 may be more beneficial because the receiving UE may receive the SL PRS at a relatively early time and thus can reduce latency.

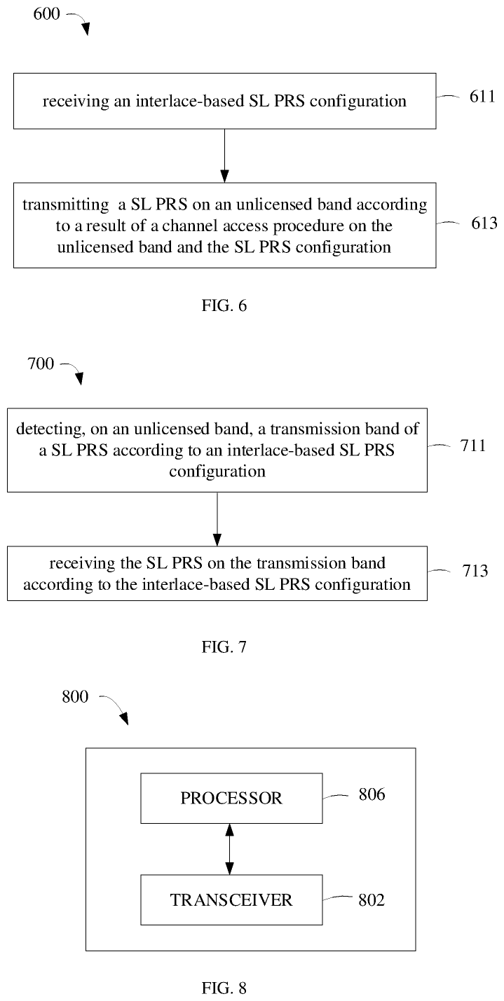

FIG. 6 illustrates a flow chart of an exemplary procedure 600 for wireless communications in accordance with some embodiments of the present disclosure. Details described in all of the foregoing embodiments of the present disclosure are applicable for the embodiments shown in FIG. 6. In some examples, the procedure may be performed by a UE, for example, UE 101A or UE 101B in FIG. 1.

In operation 611, a UE may receive an interlace-based SL PRS configuration. The SL PRS configuration may be received from another UE or a network node. The descriptions of the interlace-based SL PRS configuration described in the foregoing embodiments can apply here.

For example, the SL PRS configuration may indicate at least one of: a maximum number of occupied subbands or a set of occupied subband numbers; a maximum number of interlaces or a set of interlace indexes in a subband or a system bandwidth; or the number of symbols (denoted as “N”) for transmitting the SL PRS. The bandwidth of the subband may correspond to that of a single channel access procedure, for example, 20 Mhz. In some examples, the maximum number of occupied subbands or the set of occupied subband numbers may be predefined in a standard(s).

In operation 613, the UE may transmit an SL PRS on an unlicensed band according to a result of a channel access procedure on the unlicensed band and the SL PRS configuration.

In some embodiments, the UE may map the SL PRS to resources within the bandwidth of the unlicensed band according to the SL PRS configuration in response to the channel access procedure on the unlicensed band being successful. The SL PRS may be mapped according to a frequency first and time second manner from the lowest frequency to the highest frequency.

In some embodiments, to map the SL PRS, the UE may map the SL PRS to N symbols in the bandwidth of the unlicensed band in response to the bandwidth of the unlicensed band being equal to the maximum number of occupied subbands (for example, when a maximum of two subbands is configured and two subbands are available based on the LBT results). In some embodiments, to map the SL PRS, the UE may map the SL PRS to a plurality of N symbols in the bandwidth of the unlicensed band in response to the bandwidth of the unlicensed band being smaller than the maximum number of occupied subbands. For example, when a maximum of two subbands is configured and only one subband is available based on the LBT results and N=1, the PRS may be mapped to two symbols within the available subband.

In some embodiments, in response to the bandwidth of the unlicensed band being smaller than the maximum number of occupied subbands, the UE may copy the SL PRS mapped to a first N symbols of a plurality of N symbols or the SL PRS mapped to a second N symbols of the plurality of N symbols to a sensing region corresponding to the SL PRS mapped to the second N symbols. For example, assuming that a maximum of three subbands is configured and only one subband is available based on the LBT results and N=1, the PRS may be mapped to three symbols (denoted as symbols #1. #2 and #3, respectively) within the available subband. The UE may copy the SL PRS mapping to symbol #1, #2 or #3 to a sensing region corresponding to the SL PRS mapping to symbol #2, and may copy the SL PRS mapping to symbol #1, #2 or #3 to a sensing region corresponding to the SL PRS mapping to symbol #3.

In some embodiments, to map the SL PRS to the plurality of N symbols, the UE may map the SL PRS to a second N symbols of the plurality of N symbols based on a symbol index or slot index of the first N symbols of a plurality of N symbols. For example, assuming that a maximum of three subbands is configured and only one subband is available based on the LBT results and N=1, the PRS may be mapped to three symbols (denoted as symbols #1, #2 and #3, respectively) within the available subband. Assuming that symbol #1 is the one having the smallest symbol index (when symbols #1, #2 and #3 are within the same slot) or smallest slot index (when symbols #1, #2 and #3 are within different slots), the UE may map the SL PRS to symbol #1, #2 or #3 based on the symbol index or slot index of symbol #1.

It should be appreciated by persons skilled in the art that the sequence of the operations in exemplary procedure 600 may be changed and some of the operations in exemplary procedure 600 may be eliminated or modified, without departing from the spirit and scope of the disclosure.

FIG. 7 illustrates a flow chart of an exemplary procedure 700 for requesting an SL PRS transmission in accordance with some embodiments of the present disclosure. Details described in all of the foregoing embodiments of the present disclosure are applicable for the embodiments shown in FIG. 7. In some examples, the procedure may be performed by a UE, for example, UE 101A or UE 101B in FIG. 1.

In operation 711, a UE may detect, on an unlicensed band, a transmission band of a sidelink (SL) positioning reference signal (PRS) according to an interlace-based SL PRS configuration. In some embodiments, the UE may transmit the interlace-based SL PRS configuration to another UE. In some embodiments, the UE may receive the interlace-based SL PRS configuration from a network node. The descriptions of the interlace-based SL PRS configuration described in the foregoing embodiments can apply here.

For example, the SL PRS configuration may indicate at least one of: a maximum number of occupied subbands or a set of occupied subband numbers; a maximum number of interlaces or a set of interlace indexes in a subband or a system bandwidth; or the number of symbols (denoted as “N”) for transmitting the SL PRS. The bandwidth of the subband may correspond to that of a single channel access procedure, for example, 20 Mhz. In some examples, the maximum number of occupied subbands or the set of occupied subband numbers may be predefined in a standard(s).

In operation 713, the UE may receive the SL PRS on the transmission band according to the interlace-based SL PRS configuration. The SL PRS may be mapped according to a frequency first and time second manner from the lowest frequency to the highest frequency.

In some embodiments, to receive the SL PRS on the transmission band, the UE may receive the SL PRS at N symbols in the transmission band in response to the bandwidth of the transmission band being equal to the maximum number of occupied subbands. In some embodiments, to receive the SL PRS on the transmission band, the UE may receive the SL PRS at a plurality of N symbols in the transmission band in response to the bandwidth of the transmission band being smaller than the maximum number of occupied subbands. For example, when a maximum of two subbands is configured and the detected transmission band is one subband and N=1, the UE may receive the SL PRS at two symbols within the transmission band.

In some embodiments, in response to the bandwidth of the transmission band being smaller than the maximum number of occupied subbands, the UE may receive the SL PRS mapped to a first N symbols of a plurality of N symbols or the SL PRS mapped to a second N symbols of the plurality of N symbols at a sensing region corresponding to the SL PRS mapped to the second N symbols. In other words, the sensing region corresponding to the SL PRS mapped to the second N symbols may include the SL PRS mapped to the first N symbols of a plurality of N symbols or the SL PRS mapped to the second N symbols of the plurality of N symbols.

In some embodiments, the SL PRS received at a second N symbols of the plurality of N symbols may be mapped based on a symbol index or slot index of the first N symbols of a plurality of N symbols.

It should be appreciated by persons skilled in the art that the sequence of the operations in exemplary procedure 700 may be changed and some of the operations in exemplary procedure 700 may be eliminated or modified, without departing from the spirit and scope of the disclosure.

FIG. 8 illustrates a block diagram of an exemplary apparatus 800 according to some embodiments of the present disclosure.

As shown in FIG. 8, the apparatus 800 may include at least one processor 806 and at least one transceiver 802 coupled to the processor 806. The apparatus 800 may be a network side apparatus (e.g., a network node such as a BS) or a user side apparatus (e.g., a UE).

Although in this figure, elements such as the at least one transceiver 802 and processor 806 are described in the singular, the plural is contemplated unless a limitation to the singular is explicitly stated. In some embodiments of the present application, the transceiver 802 may be divided into two devices, such as a receiving circuitry and a transmitting circuitry. In some embodiments of the present application, the apparatus 800 may further include an input device, a memory, and/or other components.

In some embodiments of the present application, the apparatus 800 may be a UE. The transceiver 802 and the processor 806 may interact with each other to perform the operations with respect to the UEs described in FIGS. 1-7. In some embodiments of the present application, the apparatus 800 may be a network node. The transceiver 802 and the processor 806 may interact with each other to perform the operations with respect to the network nodes or networks described in FIGS. 1-7.

In some embodiments of the present application, the apparatus 800 may further include at least one non-transitory computer-readable medium.

For example, in some embodiments of the present disclosure, the non-transitory computer-readable medium may have stored thereon computer-executable instructions to cause the processor 806 to implement the method with respect to the UEs as described above. For example, the computer-executable instructions, when executed, cause the processor 806 interacting with transceiver 802 to perform the operations with respect to the UEs described in FIGS. 1-7.

In some embodiments of the present disclosure, the non-transitory computer-readable medium may have stored thereon computer-executable instructions to cause the processor 806 to implement the method with respect to the network nodes or networks as described above. For example, the computer-executable instructions, when executed, cause the processor 806 interacting with transceiver 802 to perform the operations with respect to the network nodes or networks described in FIGS. 1-7.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
at least one memory; and
at least one processor coupled with the at least one memory and configured to cause the UE to:
receive an interlace-based sidelink (SL) positioning reference signal (PRS) configuration; and
transmit an SL PRS on an unlicensed band according to a result of a channel access procedure on the unlicensed band and the SL PRS configuration.

2. The UE of claim 1, wherein the SL PRS configuration indicates at least one of:
a maximum number of occupied subbands or a set of occupied subband numbers;
a maximum number of interlaces or a set of interlace indexes in a subband or a system bandwidth; or
a number of symbols N for transmitting the SL PRS,
wherein a bandwidth of the subband corresponds to a bandwidth of a single channel access procedure.

1. Currently Amended) The UE of claim 1, wherein the SL PRS configuration is received from one or more of another UE or a network node.

4. The UE of claim 2, wherein the at least one processor is further configured to cause the UE to, in response to the channel access procedure on the unlicensed band being successful, map the SL PRS to resources within the bandwidth of the unlicensed band according to the SL PRS configuration.

5. The UE of claim 4, wherein to map the SL PRS, the at least one processor is configured to cause the UE to one or more of:
in response to the bandwidth of the unlicensed band being equal to the maximum number of occupied subbands, map the SL PRS to N symbols in the bandwidth of the unlicensed band; or
in response to the bandwidth of the unlicensed band being smaller than the maximum number of occupied subbands, map the SL PRS to a plurality of N symbols in the bandwidth of the unlicensed band.

6. The UE of claim 4, wherein the at least one processor is further configured to cause the UE to, in response to the bandwidth of the unlicensed band being smaller than the maximum number of occupied subbands, copy the SL PRS mapped to a first N symbols of a plurality of N symbols or the SL PRS mapped to a second N symbols of the plurality of N symbols to a sensing region corresponding to the SL PRS mapped to the second N symbols.

7. The UE of claim 4,, wherein the SL PRS is mapped according to a frequency first and time second manner from a lowest frequency to a highest frequency.

8. The UE of claim 5, wherein the at least one processor is further configured to cause the UE to generate the SL PRS which is mapped to a second N symbols of the plurality of N symbols based on a symbol index or slot index of a first N symbols of a plurality of N symbols.

9. The UE of claim 1, wherein the at least one processor is further configured to cause the UE to:
detect, on the unlicensed band, a transmission band of an SL PRS according to the interlace-based SL PRS configuration; and
receive the SL PRS on the transmission band according to the interlace-based SL PRS configuration.

10. A network node for wireless communication, comprising:
at least one memory; and
at least one processor coupled with the at least one memory and configured to cause the network node to:
transmit an interlace-based sidelink (SL) positioning reference signal (PRS) configuration, wherein the SL PRS configuration indicates at least one of:
a maximum number of occupied subbands or a set of occupied subband numbers;
a maximum number of interlaces or a set of interlace indexes in a subband or a system bandwidth; or
a number of symbols N for transmitting the SL PRS,
wherein a bandwidth of the subband corresponds to a bandwidth of a single channel access procedure on an unlicensed band.

11. A method performed by a user equipment (UE), the method comprising:
receiving an interlace-based sidelink (SL) positioning reference signal (PRS) configuration; and
transmitting an SL PRS on an unlicensed band according to a result of a channel access procedure on the unlicensed band and the SL PRS configuration.

12. (canceled)

13. (Canceled)

14. (canceled)

15. (canceled)

16. A processor for wireless communication, comprising:
at least one controller coupled with at least one memory and configured to cause the processor to:
receive an interlace-based sidelink (SL) positioning reference signal (PRS) configuration; and
transmit an SL PRS on an unlicensed band according to a result of a channel access procedure on the unlicensed band and the SL PRS configuration.

17. The processor of claim 16, wherein the SL PRS configuration indicates at least one of:
a maximum number of occupied subbands or a set of occupied subband numbers;
a maximum number of interlaces or a set of interlace indexes in a subband or a system bandwidth; or
a number of symbols N for transmitting the SL PRS,
wherein a bandwidth of the subband corresponds to a bandwidth of a single channel access procedure.

18. The processor of claim 16, wherein the SL PRS configuration is received from one or more of another UE or a network node.

19. The processor of claim 18, wherein the at least one controller is further configured to cause the processor to, in response to the channel access procedure on the unlicensed band being successful, map the SL PRS to resources within a bandwidth of the unlicensed band according to the SL PRS configuration.

20. The processor of claim 19, wherein to map the SL PRS, the at least one controller is configured to cause the processor to one or more of:
in response to the bandwidth of the unlicensed band being equal to a maximum number of occupied subbands, map the SL PRS to N symbols in the bandwidth of the unlicensed band; or
in response to the bandwidth of the unlicensed band being smaller than the maximum number of occupied subbands, map the SL PRS to a plurality of N symbols in the bandwidth of the unlicensed band.

21. The processor of claim 19, wherein the at least one controller is further configured to cause the processor to, in response to the bandwidth of the unlicensed band being smaller than a maximum number of occupied subbands, copy the SL PRS mapped to a first N symbols of a plurality of N symbols or the SL PRS mapped to a second N symbols of the plurality of N symbols to a sensing region corresponding to the SL PRS mapped to the second N symbols.

22. The processor of claim 19, wherein the SL PRS is mapped according to a frequency first and time second manner from a lowest frequency to a highest frequency.

23. The processor of claim 20, wherein the at least one controller is further configured to cause the processor to generate the SL PRS which is mapped to a second N symbols of the plurality of N symbols based on a symbol index or slot index of a first N symbols of a plurality of N symbols.

24. The processor of claim 16, wherein the at least one controller is further configured to cause the processor to:
detect, on the unlicensed band, a transmission band of an SL PRS according to the interlace-based SL PRS configuration; and
receive the SL PRS on the transmission band according to the interlace-based SL PRS configuration.
